(19) United States
(12) Patent Application Publication
(10) Pub. No.: US 2014/0337267 A1
(43) Pub. Date: Nov. 13, 2014

(54) GEOGRAPHIC COORDINATES BASED SOCIAL NETWORK

(71) Applicant: TollShare, Inc., Danville, CA (US)

(72) Inventors: Murali M. Karamchedu, Portland, OR (US); Ravi Asnani, Los Angeles, CA (US); Sanjay Nambiar, Los Angeles, CA (US)

(73) Assignee: TollShare, Inc., Danville, CA (US)

(21) Appl. No.: 13/892,032

(22) Filed: May 10, 2013

(51) Int. Cl. G06N 5/02

(52) U.S. Cl. CPC G06N 5/02
USPC 706/46

(57) ABSTRACT

Embodiments relate to methods, apparatuses, and media configured to identify user characteristics based at least in part on the user's association with geographic coordinates or ranges defining locations or areas of Earth's surface. Recommendations may then be provided to the user based at least in part on the identified user characteristics based on geographic coordinates. Other embodiments may be described or claimed.

### BACKGROUND

In social networks, suggestions or recommendations may be provided to users based on information input by the user. For example, when a user signs up to a social network, they may input the fact that they have gone to a particular school, like a particular product, or know a particular person. In the existing social network, this input data may be used to provide recommendations to a user. For example, the data may be used to tell a user that if the user has indicated that the user has an affinity for product X, then the user may want to consider purchasing product Y.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example of a geographic coordinates based social network, in accordance with various embodiments.

FIG. 2 illustrates an example of a geographic coordinates based recommendation determination process, in accordance with various embodiments.

FIG. 3 illustrates an example of a geographic coordinates based user characteristic determination process, in accordance with various embodiments.

FIG. 4 illustrates an example of how a geographic coordinates based user characteristics based recommendation could be constructed, in accordance with various embodiments.

FIG. 5 illustrates an example of a computing environment suitable for practicing the disclosure, in accordance with various embodiments.

FIG. 6 illustrates the collection of geographic coordinates based indices in further details, in accordance with various embodiments.

FIG. 7 illustrates an example hierarchical organization of the collection of geographic coordinates based indices, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Embodiments relate to a geographic coordinates based social network. In embodiments, one or more user characteristics may be identified based on the user's association with geographic coordinates or ranges defining locations or areas on Earth's surface. The geographic coordinates may e.g., be geodetic latitudes and longitudes. The locations may e.g., be locations where the user has spent time, where the user performed certain actions, and so forth. In some embodiments, multiple user characteristics may be identified based on different geographic coordinates or ranges of different locations or areas, and in some embodiments the user characteristics may be weighted. In embodiments, the geographic coordinates of the current location or area of the user may be determined, and compared to user characteristics of other users in the social network that are in the same location or area as the user. A recommendation may then be provided to the user based on the comparison.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

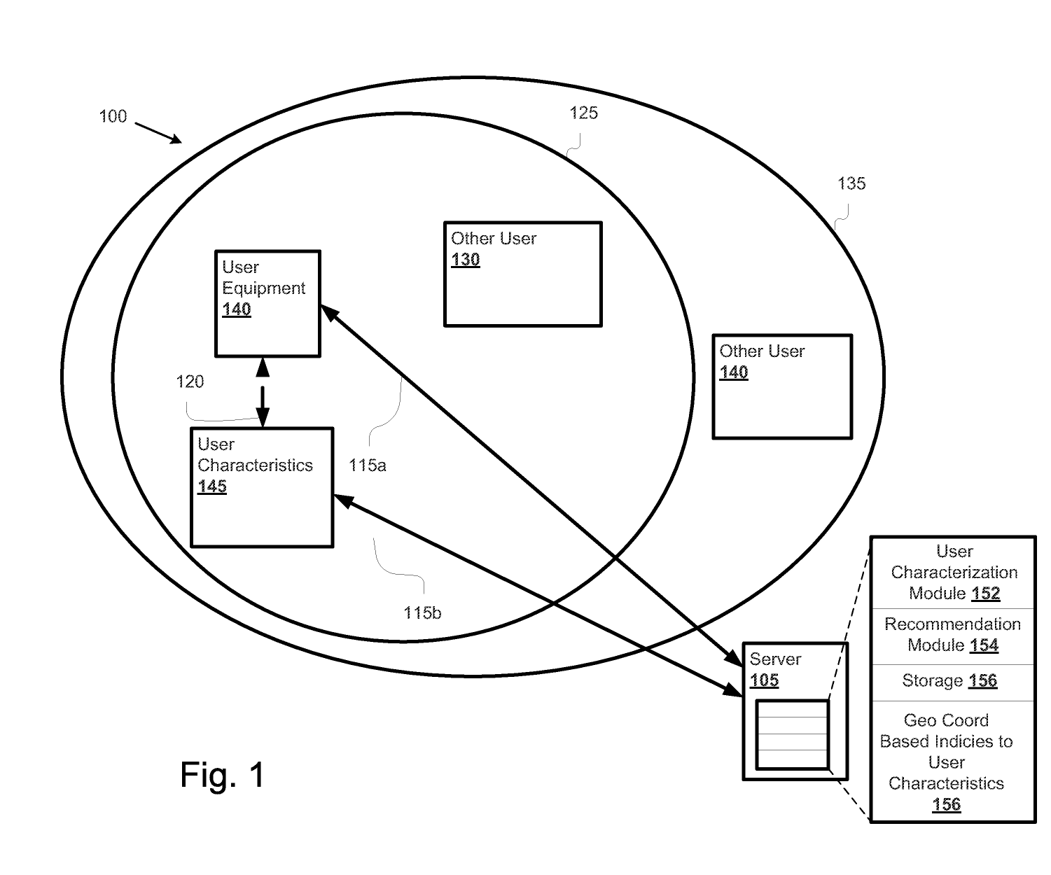

FIG. 1 depicts an example of a geographic coordinates based social network 100 in accordance with embodiments. The social network 100 may include a server. Although the server 105 is illustrated in FIG. 1 as a single entity, in some embodiments the server 105 may comprise multiple hardware or software elements which are networked or otherwise coupled to one another such that data may be transmitted and received to and from each other. For example, in some embodiments the server 105 may comprise a group or cluster of servers.

The server 105 may be coupled with a one or more user equipment 110, for example via communication link 115a. In some embodiments the user equipment 110 may be cellular phones, smartphones, tablet computers, desktop computers, laptop computers, personal digital assistants (PDAs), or some other form of computing device usable by a user of the device. Hereinafter, communication link 115a may be referred to as a first communication link 115a. As illustrated, a user of user equipment 110 may have associated user characteristics 145. In embodiments, user characteristics 145 may include user characteristics identified based on the user's associations with geographic coordinates defining locations of Earth's surface. The user characteristics may be identified by server 105, as depicted by arrow 115b. More specifically, the user characteristics 145 may be identified by a user characteristic module 152, to be described more fully below.

The communication link 115a may be wired or wireless. For example, the communication link 115a may be configured to transmit data between the server 105 and the user equipment 110 over a wired network such as a public switched telephone network (PSTN), a circuit switched network, an ethernet connection, a USB connection, a firewire connection, or some other wired connection. Alternatively, the communication link 115a may be wireless and involve a wireless connection such as an institute of electrical and electronics engineers (IEEE) 802.11 specified WiFi connection, an IEEE 802.16 specified Worldwide Interoperability for Microwave Access (WiMAX) connection, a third generation partnership project (3GPP) network such as a universal mobile telecommunications system (UMTS) connection, a long term evolution (LTE) connection, or some other wireless connection such as any other 2G/3G/4G/4.5G/5G connection known or hereafter developed. In some embodiments, the communication link 115a may be a combination of two or more of the above listed network types.

In some embodiments, the user equipment 110 may be within a current location or area 125, as described in further detail below. The current location or area 125 may include one or more other users 130. In some embodiments, the other users 130 may be other users of the social network 100.

As noted, the user equipment 110 may be within a current location/area 125. In embodiments, the current location/area 125 may be identified based on geographic coordinates of the user equipment 110. In other embodiments, the current location/area 125 of the user equipment 110 may be determined based on any one of a number of location systems or techniques such as the global positioning systems, cell phone triangulation, and so forth.

The geographic coordinates of user equipment 110, associated locations of the users, locations/areas, etc. may be expressed in terms of any one of a number of geographic coordinates, e.g., geodetic latitude/longitude, that are valued in accordance with a mathematically defined reference ellipsoid that approximates the Earth. The geographic coordinates may be associated with the user equipment, locations/areas, via any one of a number of techniques, e.g., geotagging.

In alternate embodiments, other geographic coordinates with other geographic reference systems may also be used, including but are not limited to, e.g., geocentric coordinates that are valued in accordance with a X-Y-Z reference centered at Earth's center, or spherical coordinates that are valued based on the radial distances from Earth's center, along with polar angles measured from the zenith directions of the positions, and azimuth angles of the positions based on orthogonal projections on corresponding reference planes that pass through Earth's center and orthogonal to the zenith directions.

In embodiments, a current range 135 including the current location/area 125 may be identified, and in some embodiments may also include an other user 140 of the social network 100. In embodiments, the geographical coordinates of the current range 135 may be based on the significant aspect of the geographic coordinates of a location. For example, if current location/area 125 of user equipment 110 is the City of San Francisco, which geodetic latitude/longitude is 37° 45′ 27.6726″, −122° 24′ 54.579″ (in degree, minute and second form), by considering only the significant degree portion, that is 37° and −122° (implicitly including 0′ 00″ to 59′ 59″), the user equipment 110 may be considered to be located within the current range 135, such as the Bay Area, surrounding the City of San Francisco.

In embodiments, the current location 125 may be based on geographic coordinates of the geographic coordinate range of the current area 135. If the geographic coordinate range of the current area 135 was, for example, 37°, any min, any sec and −122°, any min, any sec, then the current location 125 may be based on specific geographic coordinates with the range, thereby defining a more specific location such as a building, a block, a street, a neighborhood, or some other type of area identifier within the greater area. It will be understood that the above statements describe one example of the general concept that the current location 125 may be smaller than the current area 135 based at least in part on the use of the location coordinates. It will also be noted that even though for clarity, the server 105 is shown outside of the current location 125 and the current area 135, the location of the server 105 may be anywhere, inside or outside the location/area of interest.

Still referring to FIG. 1, in embodiments, the user characteristics 145 may be identified by a user characteriziation module 152 of the server 105, to be described more fully below.

In embodiments, server 105 may further include recommendation module 154, and storage 156. As will be described in more detail below, recommendation module 154 may be configured to make recommendations to users of the social network based at least in part on the user characteristics of the users of the social network 100, the user characteristics identified based at least in part on the user's geographic coordinates. In embodiments, storage 156 may be configured to store a collection 158 of geographic coordinates based indices indexing a plurality of geographic coordinates to user characteristics.

In embodiments, user characterization module 152 and recommendation module 154 may be implemented in any combination of hardware and/or software. In embodiments, the combination of hardware and/or software may include processor(s), memory and executable instructions implementing the functions described herein. In embodiments, in lieu of being two separate modules, user characterization module 152 and recommendation module 154 may share some common functions and/or resources. For example, user characterization module 152 and recommendation module 154 may share common communication functions and components for communicating with user equipment 110 and providers of online information. As a further example, user characterization module 152 and recommendation module 154 may share processor and/or memory resources. In embodiments, some functions of user characterization module 152 may be moved to recommendation module 154, or vice versa, or be combined. In embodiments, storage 156 may be any one of a number of non-volatile magnetic, optic, and/or solid state storage. Storage 156 may further include one or more caches.

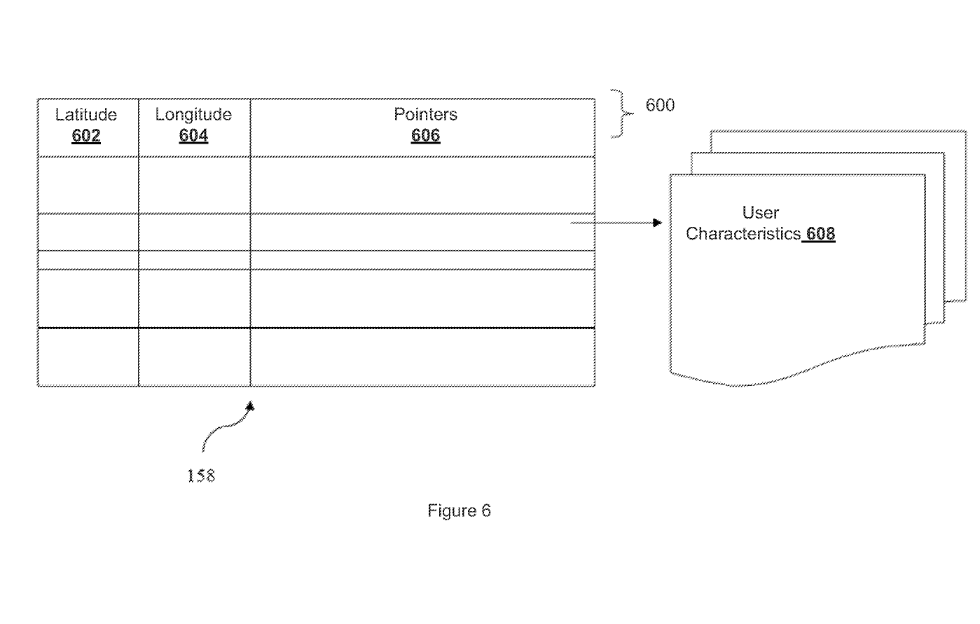

FIG. 6 illustrates collection 158 of geographic coordinates based indices in further detail, in accordance with various embodiments. As shown, in embodiments, each stored geographic coordinates based index 600 may include a set of geographic coordinates of a location on Earth's surface, e.g., latitude 602 and longitude 604, and a pointer 606. Pointer 606 may point to a location where user characteristics 608 associated with the various locations/areas may be found and retrieved. The user characteristics 608 may be earlier determined by server 105 to be associated with the locations/areas, using any one of a number of resources, including resources available on the Internet.

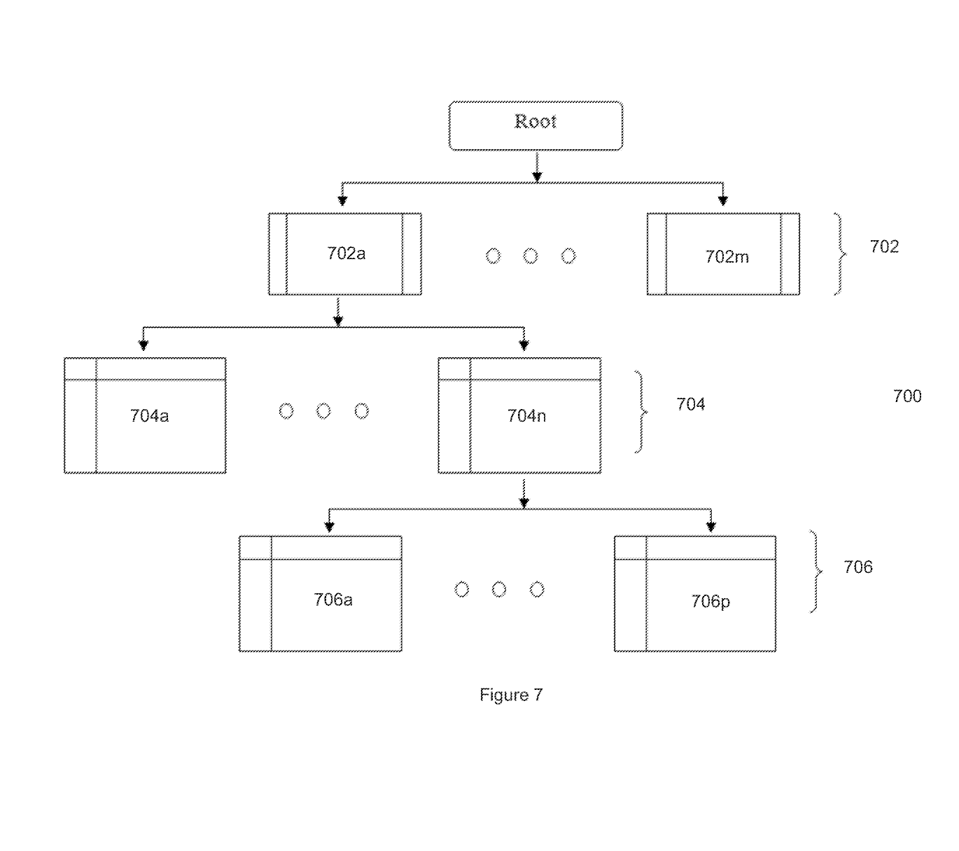

FIG. 7 illustrates an example hierarchical organization of geographic coordinates based indices 158, in accordance with various embodiments. Example organization 700 may be a hierarchical organization/structure having a number of organization levels, including one or more intermediate or node levels 702-704 and the lowest or leaf level 706. In embodiments, geographical coordinate based indices having geographic coordinates of various locations indexing the locations to user characteristics may be stored in the lowest or leaf level 706, such as 706a . . . 706p. Further, geographical coordinate based indices having geographic coordinate ranges defining areas and/or regions of various sizes indexing the areas/regions to each other and to the user characteristics may be stored in the one or more intermediate levels 702, 704, and so forth, such as 702a . . . 702m and 704a . . . 704n.

For example, in one embodiment, the lowest level 706 may store the geographic coordinates based indices indexing cities, such as San Francisco, Los Angeles, to user characteristics. A next immediate intermediate level, e.g., level 704, may store geographic coordinate ranges defining States, such as California, Oregon, indexing the states to the indices of the cities within the States. Further, another intermediate level (not shown) above intermediate level 704 may store geographic coordinate ranges representing Countries, such as United States, Canada, indexing the Countries to the indices of the States or Provinces within the Countries. Still further, yet another intermediate level, such as intermediate level 702 may store geographic coordinate ranges representing Continents, such as North America, Europe and so forth, indexing the Continents to the indices of the Countries.

The above example is not intended to be limiting on the present disclosure. The present disclosure may be practiced with any data organization or structure, depending on the application. In the case of hierarchical organization, the hierarchical organization may have any number of levels, with the nodes of the intermediate levels storing geographic coordinate ranges defining any geographic, political, cultural, social, and/or economic organizations.

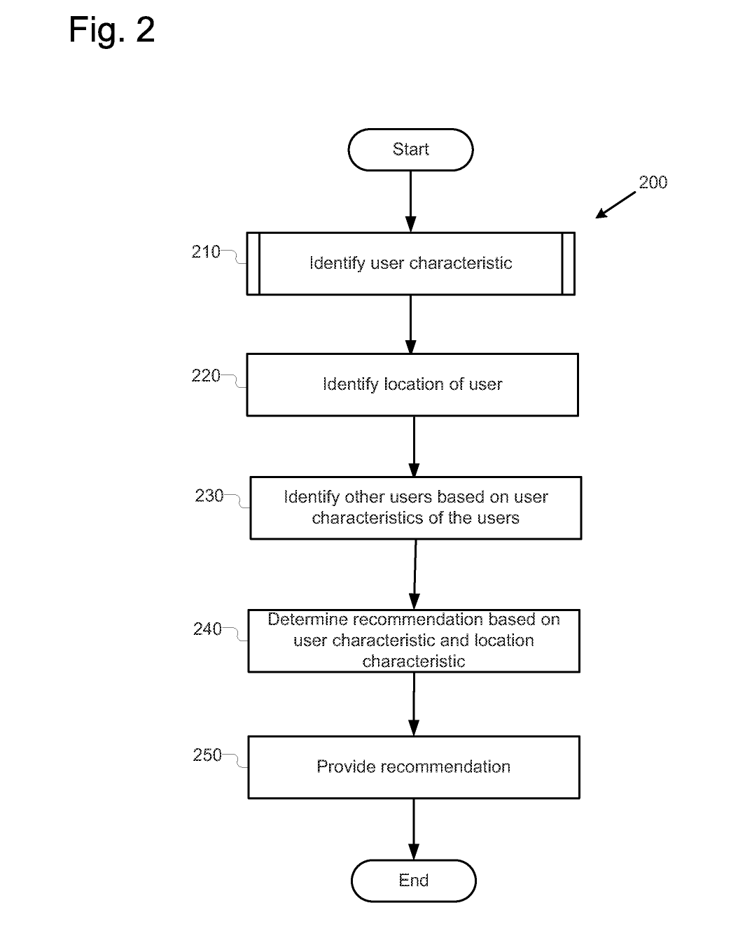

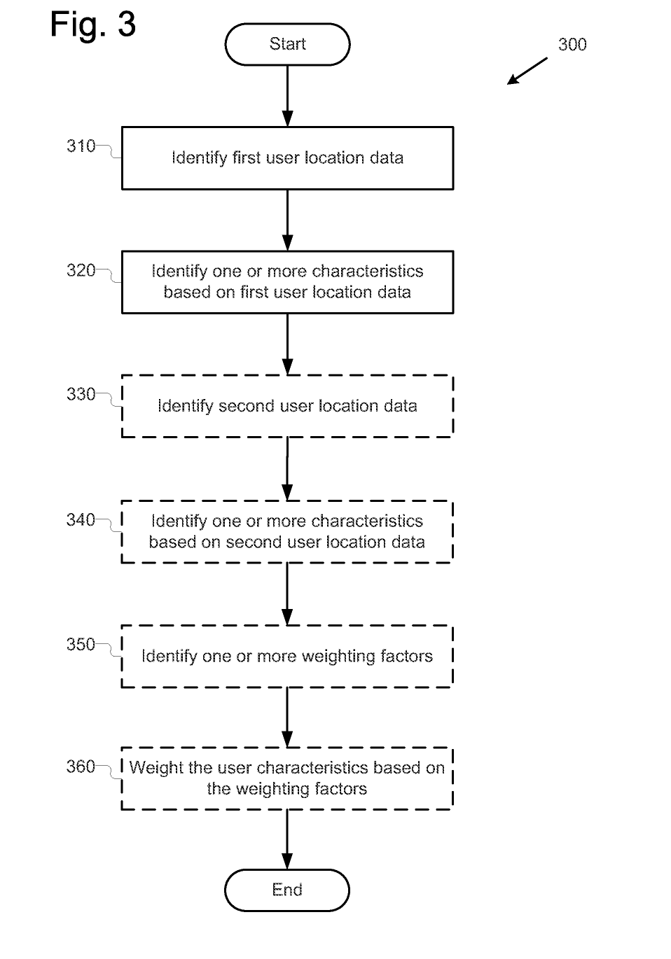

FIG. 2 describes a process 200 of using the social network 100 described in FIG. 1. In some embodiments, the process 200 may be performed by the server 105. In embodiments, a user characteristic may be identified, e.g., by user characterization module 152, at 210. As described herein, the user characteristic will refer to the user of the user equipment 110. In general, the user characteristic may be a characteristic of the user such as what the user likes or is familiar with. The user characteristic may be identified based on location data of the user, as defined in greater detail below with respect to FIG. 3.

Next, for the example embodiments, the user's location may be identified at 220. For example one or both of the user's current location/area 125 and/or current range 135 may be identified at 220.

Next, other users of the social network may be identified at 230. The user characteristics of those users, which may be similar to user characteristics 145 of the first user, may be identified. Specifically, the user characteristics of each identified user may be based on location or geographic information of those users. The user characteristics for the other users may be identified with reference to the geographic coordinates based index 600 described above with reference to FIG. 6.

Next, a recommendation may be determined, e.g., by recommendation module 154 at 240. In embodiments, the recommendation for the user may be based at least in part on the identified user characteristic, and the user characteristics of the other users identified at 230. As an example, if the user characteristic indicates that the user has an affinity for Italian food, there may be an individual nearby who also has an affinity for Italian food. In that scenario, the recommendation may be that the user should contact the individual due to their shared affinity for a specific type of cuisine. Similarly, if the user characteristic indicates that the user enjoys hiking, and there is an individual nearby who also enjoys hiking, then the recommendation may be that the user should contact the individual due to their common interest. The recommendation may then be provided to the user, e.g., by recommendation module 154, at 250.

It will be recognized that even though process 200 depicts that the location of the user is identified at 220 before other users are identified at 230, other embodiments may have these processes reversed. For example, in one embodiment the location of the user may be identified at 220. Based on the location of the user identified at 220, then other users such as other users 130 and 140 may be identified based at least in part on the other users 130 and 140 being within the current location 125 or current range 135 of the user. The user characteristics of those other users may be compared to the user characteristics 145 of the user. If the user characteristics of one or more of the other users and the user characteristics 145 of the user are similar, then the recommendation module 154 may output a recommendation to the user which may, for example include information regarding the one or more other users. The information on the other users may include user characteristics of the users, names, phone numbers, email addresses, or other contact or identification information of the other users.

However, in another embodiment, the user characteristics 145 of the user may be identified at 210. The other users may be identified through comparison of the user characteristics 145 with the user characteristics of all of, or a subset of, the other users in the social network, regardless of the current location or range of the user or other users at 230. The location of the user may then be identified at 220. If the location of the user identified at 220 is determined to be near the other users identified at 230, then the recommendation may be determined at 240 and provided at 250. Similarly to the embodiment above, the recommendation may include user characteristics, contact, or identification information of the identified other users.

FIG. 3 depicts an example of a process 300 for identifying a user characteristic. The process 300 may be used, for example, to identify a user characteristic at 210 in FIG. 2. Initially, first user location data, such as the user's association with geographic coordinates, may be identified, e.g., by user characterization module 152, at 310. The user location data, e.g., association with geographic coordinates, may then be used to identify, e.g., by user characterization module 152, one or more user characteristics at 320. In embodiments, the user location data and the user characteristics may be based on a variety of elements. For example, the user location data may indicate where a user is from, where they have lived, where they are currently living, or some other location data. The user characteristics may then be identified based on that location data. For example, a person that grew up in a certain location or country may have an affinity for a certain type of food. Alternatively, a person that is currently living in a location may have an affinity for a local sports team, a certain type of music, or some other element. As another example, a user that spends a significant amount of time in a museum may have an affinity for museums. As yet another example, a user that spends a significant amount of time in a particular store, for example a bookstore or a music store, may have an affinity for shopping, books, or music, respectively. In general, multiple user characteristics may be reasonably inferred from where a user has spent time. As another example, a user characteristic may be based on an action of a user at a location. For example, if a user takes a photograph at a certain location which is near a landmark, it may be reasonably inferred that the user has an interest in that landmark. A user characteristic may then be reasonably inferred, such as the user likes history from a given period that the landmark represents. Alternatively, if the user takes a photograph of a theatre, then it may be reasonably inferred that the user has an interest in the theatre.

In embodiments, as described earlier the user location data may be identified based on one or more of geodetic coordinates such as latitude and/or longitude. In some embodiments, one or both of the location data and/or the user characteristics may be identified automatically or semi-automatically without specific input from the user. In some embodiments, the user may provide input related to the location data, for example where the user was born, where the user took a particular photograph, where the user works, where the user went to school, etc.

In alternative embodiments, second user location data, e.g., association with one or more geographic or geodetic coordinates, may be identified, e.g., by user characterization module 152, at 330, and one or more user characteristics may be identified based on the second user location data at 340. The second user location data and the user characteristics identified at 330 or 340 may be similar to the first user location data and the user characteristics described above at 310 and 320, and may likewise be identified automatically, semi-automatically, or based at least in part on input from the user.

During recommendation, one or more weighting factors may be identified, e.g., by recommendation module 154, at 350. An example of a weighting factor may be a temporal element regarding the user location data. The temporal element may indicate how current the user location data and the related user characteristic are. For example, the first user location data at 310 may relate to a bookstore, and so the user characteristic may be that the user has an affinity for bookstores. However, if the temporal data indicates that the user has not been inside of a bookstore in a significant period of time, for example several years, then it may be inferred that either the user has no interest in bookstores, or that the user has a lesser interest in bookstores.

As another example, one or more user characteristics may be based on the first user location data identified at 320 which indicates that the user has an affinity for French cuisine due to an extended period of time in France. Similarly, the one or more characteristics based on the second user location data identified at 340 may indicate that the user has an affinity for Italian cuisine based on an extended period of time in Italy. However, if the temporal data of the first location data indicates that the user has been to France less recently than Italy, or that the user only spent a small amount of time in France as compared to Italy, then the affinity for French cuisine may be reduced or eliminated, and the affinity for Italian cuisine may be increased. These weighting factors may be applied at 360.

Although the weighting factors are described above with respect to the first user, in other embodiments weighting factors may additionally or alternatively be applied to the user location data and user characteristics of the second user that is identified in the recommendation at 240 and 250, for example using process 300 described above. In other words, the recommendation determined at 240 and provided at 250 may be based on at least weighted first and second characteristics of the second user in addition to, or instead of, weighted first and second characteristics of the first user. Therefore, in embodiments the characteristics used to determine the affinities of the first and second users may be dynamic and based on an entire lifetime experience, or a subset of that experience, of one or both of the first or second users.

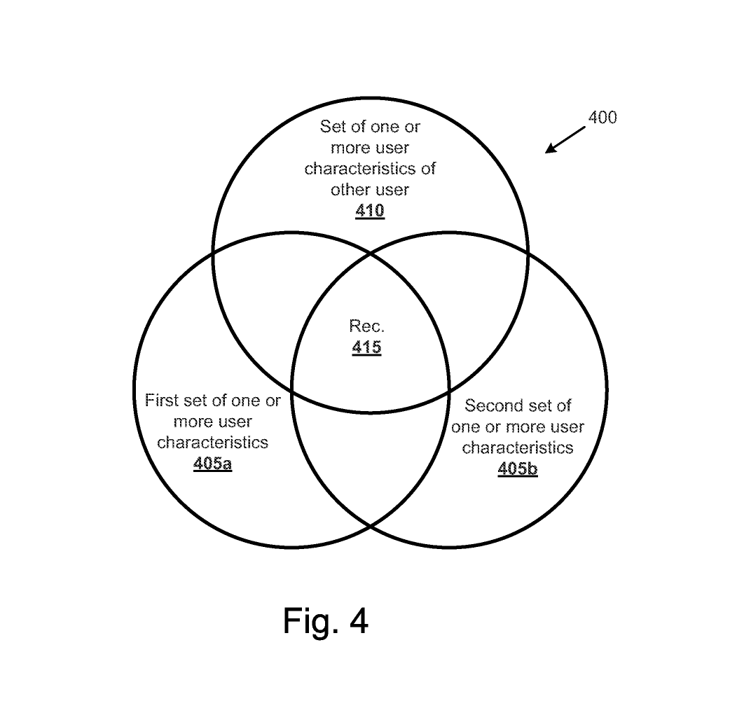

FIG. 4 provides a visual example 400 of how a recommendation may be provided based on the processes described above in FIG. 2 or 3. Specifically, first and second sets of one or more user characteristics 405a and 405b may be determined, for example through process 300, e.g., by user characterization module 152, described above. As an example, a first set of one or more user characteristics 405a may relate to one or more characteristics of the user based at least in part on where the user is currently living. The second set of one or more user characteristics 405b may relate to one or more characteristics of the user based at least in part on where the user used to live. However, in other embodiments the user characteristics may be based on other location-based criteria such as where the user has spent time, actions the user has performed at a specific location, or some other basis as described above. In some embodiments, the user characteristics 405a and 405b may be weighted, as described above with respect to FIG. 3. As shown in FIG. 4, at least some of the first set of one or more user characteristics 405a and the second set of one or more user characteristics 405b may overlap. For example, the first set of one or more user characteristics 405a may indicate that the user has an affinity for seafood based on the fact that the user has spent significant time in a coastal area. The second set of one or more user characteristics 405b may indicate that the user has an affinity for seafood based on the fact that the user has frequented seafood restaurants.

In addition, a set of one or more user characteristics 410 of another user of the social network may be identified, for example, e.g., by reference to the geographic coordinates based index 700 described in FIG. 7. As shown in FIG. 4, the set of one or more user characteristics of the other user 410 may overlap one or both of the first and second sets of one or more user characteristics 405a and 405b. The recommendation 415 may then be provided, e.g., by recommendation module 154, to the user based, for example, on where the set of one or more user characteristics of the other user 410 overlaps the first and second set of one or more user characteristics 405a and 405b.

In the embodiment depicted in FIG. 4, the recommendation 415 is based on the overlap of three sets of data. However, in other embodiments additional or alternative recommendations may be provided. In those embodiments, the recommendations may be provided based only on overlap between two or more sets of data, or on a single set of data. For example, in one embodiment the first set of one or more user characteristics 405a may be weighted much more strongly than the second set of one or more user characteristics 405b, and in that embodiment the recommendation may only be based on where the first set of one or more user characteristics 405a overlaps the set of one or more user characteristics of the other user 410. In general, FIG. 4 is intended to depict an example of how comparisons of data sets related to the user may be used to determine recommendations to the user, and alternative embodiments and examples may exist.

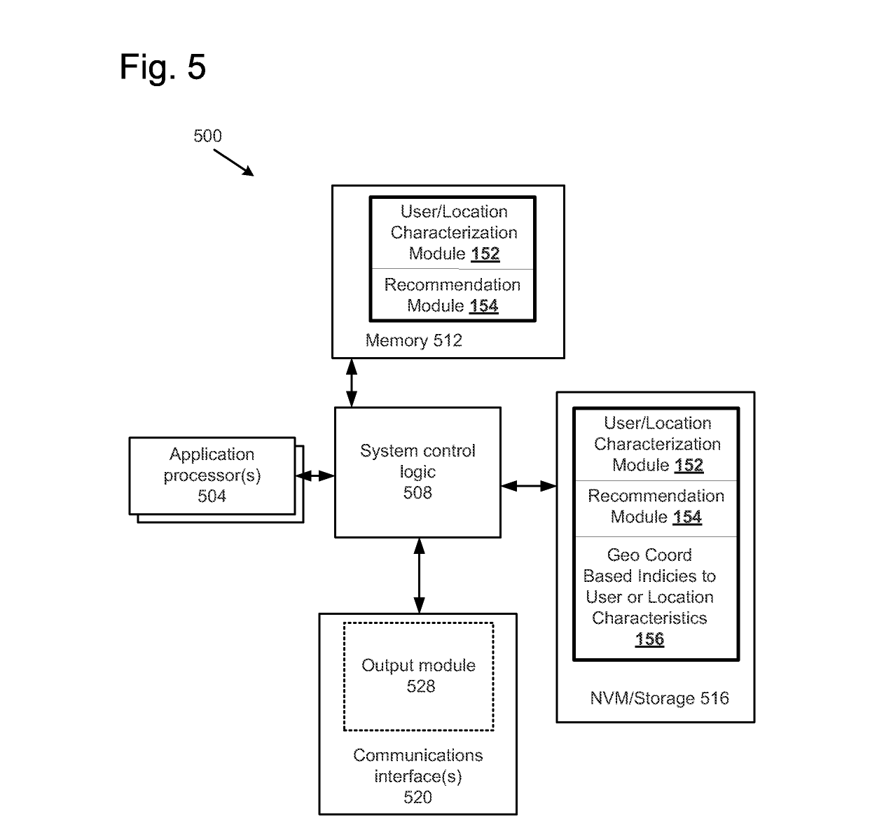

FIG. 5 illustrates, for one embodiment, an example computer system 500 suitable for practicing embodiments of the present disclosure. Computer system 500 may be one or more of server 105, or user equipment 110. As illustrated, example computer system 500 may include system control logic 508 coupled to at least one of the processor(s) 504, system memory 512 coupled to system control logic 508, non-volatile memory (NVM)/storage 516 coupled to system control logic 508, and one or more communications interface(s) 520 coupled to system control logic 508. In various embodiments, the one or more processors 504 may be a processor core.

System control logic 508 for one embodiment may include any suitable interface controllers to provide for any suitable interface to at least one of the processor(s) 504 and/or to any suitable device or component in communication with system control logic 508.

System control logic 508 for one embodiment may include one or more memory controller(s) to provide an interface to system memory 512. System memory 512 may be used to load and store data and/or instructions, for example, for computer system 500. In one embodiment, system memory 512 may include any suitable volatile memory, such as suitable dynamic random access memory (DRAM), for example.

System control logic 508, in one embodiment, may include one or more input/output (I/O) controller(s) to provide an interface to NVM/storage 516 and communications interface(s) 520.

NVM/storage 516 may be used to store data and/or instructions, for example. NVM/storage 516 may include any suitable non-volatile memory, such as flash memory, for example, and/or may include any suitable non-volatile storage device(s), such as one or more hard disk drive(s) (HDD(s)), one or more solid-state drive(s), one or more compact disc (CD) drive(s), and/or one or more digital versatile disc (DVD) drive(s), for example.

The NVM/storage 516 may include a storage resource physically part of a device on which the computer system 500 is installed or it may be accessible by, but not necessarily a part of, the device. For example, the NVM/storage 516 may be accessed over a network via the communications interface(s) 520.

System memory 512 and NVM/storage 516 may be configured to store, in particular, temporal or persistent copies of user characterization and recommendation modules 152 and 154. NVM/storage 516 may further include geographic coordinates based indices to user characteristics.

Communications interface(s) 520 may provide an interface for computer system 500 to communicate over one or more network(s) and/or with any other suitable device. Communications interface(s) 520 may include any suitable hardware and/or firmware, such as a network adapter, one or more antennas, a wireless interface, and so forth. In various embodiments, communication interface(s) 520 may include an interface for computer system 500 to use NFC, optical communications (e.g., barcodes), BlueTooth or other similar technologies to communicate directly (e.g., without an intermediary) with another device. In addition, the communications interface(s) 520 may include an output module 528, which may be configured to output the recommendation to the user.

In embodiments, modules 152 and 154, system control logic 508, and/or application processor(s) 504 may be configured to, either separately or in combination with one another, perform the processes described above such as processes 200 or 300. Once a recommendation has been identified or determined, for example at 240 in process 200, then the recommendation may be provided to the user via the output module 528.

Computer-readable media (including non-transitory computer-readable media), methods, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A method comprising:
identifying, by a computing device of a social network, first one or more characteristics of a first user of a plurality of users of the social network based at least in part on the first user's association with first one or more geographic coordinates or first geographic coordinate ranges correspondingly defining first one or more locations or areas on Earth's surface;
identifying, by the computing device, second one or more characteristics of a second user of the plurality of users based at least in part on the second user's association with second one or more geographic coordinates or second geographic coordinate ranges correspondingly defining second one or more locations or areas on Earth's surface;
providing, by the computing device, a recommendation to the first user based at least in part on a comparison of the first one or more characteristics of the first user with the second one or more characteristics of the second user, the recommendation comprising information of the second user.

2. The method of claim 1, wherein the first one or more characteristics of the first user comprises a first characteristic based on first geographic coordinates of a first location or first geographic coordinate ranges of a first area the first user is associated with, and a second characteristic based on second geographic coordinates of a second location or second geographic coordinate ranges of a second area the first user is associated with, and the method further comprises:
weighting, by the computing device, the first characteristic with a first weight to produce a weighted first characteristic;
weighting, by the computing device, the second characteristic with a second weight to produce a weighted second characteristic; and
providing the recommendation based at least in part on the weighted first characteristic and the weighted second characteristic of the first user.

3. The method of claim 2, wherein the second one or more characteristics of the second user comprises a third characteristic based on third geographic coordinates of a third location or third geographic coordinate ranges of a third area the second user is associated with, and a fourth characteristic based on fourth geographic coordinates of a fourth location or fourth geographic coordinate ranges of a fourth area the second user is associated with, and the method further comprises:
weighting, by the computing device, the third characteristic with a third weight to produce a weighted third characteristic;
weighting, by the computing device, the fourth characteristic with a fourth weight to produce a weighted fourth characteristic; and
providing the recommendation based at least in part on the weighted third characteristic and the weighted fourth characteristic of the second user.

4. The method of claim 2, wherein the first and second weights are based at least in part on first and second ages of the first user's association with the first and second locations or areas having the first and second geographic coordinates or first and second geographic coordinate ranges, from which the first and second characteristics were identified.

5. The method of claim 1, wherein the second one or more characteristics of the second user comprises a first characteristic based on first geographic coordinates of a first location or first geographic coordinate ranges of a first area the second user is associated with, and a second characteristic based on second geographic coordinates of a second location or second geographic coordinate ranges of a second area the second user is associated with, and the method further comprises:
weighting, by the computing device, the first characteristic with a first weight to produce a weighted first characteristic;
weighting, by the computing device, the second characteristic with a second weight to produce a weighted second characteristic; and
providing the recommendation based at least in part on the weighted first characteristic and the weighted second characteristic of the second user.

6. The method of claim 1, wherein at least one of the first or second user's association with one of the first or second one or more geographic coordinates or geographic coordinate ranges is based at least in part on an action taken by the corresponding first or second user at a location defined by the one geographic coordinates or an area defined by the one geographic coordinate ranges.

7. The method of claim 1, wherein the geographic coordinates or ranges comprise geodetic coordinates or ranges, geocentric coordinates or ranges, or spherical coordinates or ranges.

8. One or more computer readable media comprising instructions configured to, upon execution of the instructions by a computing device of a social network, cause the computing device to:
identify first one or more characteristics of a first user of a plurality of users of the social network based at least in part on the first user's association with first one or more geographic coordinates or first geographic coordinate ranges correspondingly defining first one or more locations or areas on Earth's surface;
identify second one or more characteristics of a second user of the plurality of users based at least in part on the second user's association with second one or more geographic coordinates or second geographic coordinate ranges correspondingly defining second one or more locations or areas on Earth's surface; and
provide a recommendation to the first user based at least in part on a comparison of the first one or more characteristics of the first user with the second one or more characteristics of the second user, the recommendation comprising information of the second user.

9. The storage medium of claim 8, wherein the first one or more characteristics of the first user comprises a first characteristic based on first geographic coordinates of a first location or first geographic coordinate ranges of a first area the first user is associated with, and a second characteristic based on second geographic coordinates of a second location or second geographic coordinate ranges of a second area the first user is associated with, and the computing device is further caused to:
weight the first characteristic with a first weight to produce a weighted first characteristic;
weight the second characteristic with a second weight to produce a weighted second characteristic; and
provide the recommendation based at least in part on the weighted first characteristic and the weighted second characteristic of the first user.

10. The storage medium of claim 9, wherein the second one or more characteristics of the second user comprises a third characteristic based on third geographic coordinates of a third location or third geographic coordinate ranges of a third area the second user is associated with, and a fourth characteristic based on fourth geographic coordinates of a fourth location or fourth geographic coordinate ranges of a fourth area the second user is associated with, and the instructions are configured to, upon execution of the instructions by a computing device of a social network, cause the computing device to:
weight the third characteristic with a third weight to produce a weighted third characteristic;
weight the fourth characteristic with a fourth weight to produce a weighted fourth characteristic; and
provide the recommendation based at least in part on the weighted third characteristic and the weighted fourth characteristic of the second user.

11. The storage medium of claim 9, wherein the first and second weights are based at least in part on first and second ages of the first user's association with the first and second locations or areas having the first and second geographic coordinates or first and second geographic coordinate ranges, from which the first and second characteristics were identified.

12. The storage medium of claim 8, wherein the second one or more characteristics of the second user comprises a first characteristic based on first geographic coordinates of a first location or first geographic coordinate ranges of a first area the second user is associated with, and a second characteristic based on second geographic coordinates of a second location or second geographic coordinate ranges of a second area the second user is associated with, and the instructions are configured to, upon execution of the instructions by a computing device of a social network, cause the computing device to:
weight the first characteristic with a first weight to produce a weighted first characteristic;
weight the second characteristic with a second weight to produce a weighted second characteristic; and
provide the recommendation based at least in part on the weighted first characteristic and the weighted second characteristic of the second user.

13. The storage medium of claim 8, wherein at least one of the first or second user's association with one of the first or second one or more geographic coordinates or geographic coordinate ranges is based at least in part on an action taken by the corresponding first or second user at a location defined by the one geographic coordinates or an area defined by the one geographic coordinate ranges.

14. The storage medium of claim 8, wherein the geographic coordinates or ranges comprise geodetic coordinates or ranges, geocentric coordinates or ranges, or spherical coordinates or ranges.

15. An apparatus for providing social networking service to a social network, comprising:
one or more processors; and
a user characterization module coupled with the one or more processors, the user characterization module configured to:
identify first one or more characteristics of a first user of a plurality of users of the social network based at least in part on the first user's association with first one or more geographic coordinates or first geographic coordinate ranges correspondingly defining first one or more locations or areas on Earth's surface; and
identify second one or more characteristics of a second user of the plurality of users based at least in part on the second user's association with second one or more geographic coordinates or second geographic coordinate ranges correspondingly defining second one or more locations or areas on Earth's surface; and
a recommendation module coupled with the user characterization module and configured to provide a recommendation to the first user based at least in part on a comparison of the first one or more characteristics of the first user with the second one or more characteristics of the second user, the recommendation comprising information of the second user.

16. The apparatus of claim 15, wherein the first one or more characteristics of the first user comprises a first characteristic based on first geographic coordinates of a first location or first geographic coordinate ranges of a first area the first user is associated with, and a second characteristic based on second geographic coordinates of a second location or second geographic coordinate ranges of a second area the first user is associated with, and the recommendation module is further configured to:
weight the first characteristic with a first weight to produce a weighted first characteristic;
weight the second characteristic with a second weight to produce a weighted second characteristic; and
provide the recommendation based at least in part on the weighted first characteristic and the weighted second characteristic of the first user.

17. The apparatus of claim 16, wherein the second one or more characteristics of the second user comprises a third characteristic based on third geographic coordinates of a third location or third geographic coordinate range of a third area the second user is associated with, and a fourth characteristic based on fourth geographic coordinates of a fourth location or fourth geographic coordinate ranges of a fourth area the second user is associated with, and the recommendation module is further configured to:
weight the third characteristic with a third weight to produce a weighted third characteristic;
weight the fourth characteristic with a fourth weight to produce a weighted fourth characteristic; and
provide the recommendation based at least in part on the weighted third characteristic and the weighted fourth characteristic of the second user.

18. The apparatus of claim 16, wherein the first and second weights are based at least in part on first and second ages of the first user's association with the first and second locations or areas having the first and second geographic coordinates or first and second geographic coordinate ranges, from which the first and second characteristics were identified.

19. The apparatus of claim 15, wherein the second one or more characteristics of the second user comprises a first characteristic based on first geographic coordinates of a first location or first geographic coordinate ranges of a first area the second user is associated with, and a second characteristic based on second geographic coordinates of a second location or second geographic coordinate ranges of a second area the second user is associated with, and the recommendation module is further configured to:
weight the first characteristic with a first weight to produce a weighted first characteristic;
weight the second characteristic with a second weight to produce a weighted second characteristic; and
provide the recommendation based at least in part on the weighted first characteristic and the weighted second characteristic of the second user.

20. The apparatus of claim 15, wherein at least one of the first or second user's association with one of the first or second one or more of geographic coordinates or geographic coordinate ranges is based at least in part on an action taken by the corresponding first or second user at a location defined by the one geographic coordinates or an area defined by the one geographic coordinate ranges.

21. The apparatus of claim 15, wherein the geographic coordinates or ranges comprise geodetic coordinates or ranges, geocentric coordinates or ranges, or spherical coordinates or ranges.
